(19) United States
(12) Patent Application Publication
(10) Pub. No.: US 2009/0222454 A1
(43) Pub. Date: Sep. 3, 2009

(54) METHOD AND DATA PROCESSING SYSTEM FOR RESTRUCTURING WEB CONTENT

(75) Inventors: Stefan Liesche, Boblingen (DE); Andreas Naurerz, Boblingen (DE)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATIN, Armonk, NY (US)

(21) Appl. No.: 12/097,445

(22) PCT Filed: Nov. 29, 2006
(86) PCT No.: PCT/EP06/69045

§ 371 Date: Sep. 3, 2008

(30) Foreign Application Priority Data
Dec. 21, 2005 (EP) EP05112627.4

(51) Int. Cl. G06F 17/30

(52) U.S. Cl. 707/10; 707/102; 707/E17.01; 707/E17.044; 707/E17.032; 707/200

(57) ABSTRACT

There is provided a method and data processing system for restructuring web content which consists of a plurality of web pages. The method comprises the steps of generating a log file which comprises a history of web pages. The history of web pages comprises all web pages that have been selected by a user from the plurality of web pages. An access frequency is determined for each of the selected web pages by use of the history of web pages. A subset of web pages is determined which comprises the web pages that have been accessed by the user with the largest access frequency. This subset is limited to a maximum number of web pages. The plurality of web pages is generally arranged in a tree structure. The tree structure is rooted at the starting webpage. The web pages that are comprised in the subset of web pages is either linked to a portlet which is directly linked to the starting webpage or the subset of web pages is determined at the point in time when the user accesses the user specific special webpage which is also directly linked to the starting webpage. The method in accordance with the invention is particularly advantageous as it allows a user to directly access a webpage within a few clicks away from the starting webpage. Thus he does not have to click through many web pages in order to arrive at his favorite web pages.

### FIELD OF THE INVENTION

The invention relates to a method and data processing system for restructuring web content in general and to a method and data processing system for restructuring web content in order to increase the usability of the web content in particular.

### BACKGROUND AND RELATED ART

Web content generally consists of a plurality of web pages. The term web content refers here to the content of the World Wide Web in general as well as to the content of an intranet of a company or to the content of a portal. In this context, the term portal refers to the any kind of web page that is accessible by use of a web browser. The web pages of the plurality of web pages that constitute the web content are generally arranged in a tree structure which is generally rooted at a starting webpage.

A typical scenario is that a user accesses the intranet of his company or a portal at the corresponding starting webpage. In order to access one of his favorite web pages he possibly has to click through many other web pages in order to arrive from the starting webpage at one of his favorite web pages. If the user is for example responsible for the administration of a sub-unit of his company, one of his favorite web pages might be the webpage by which he can administrate the sub-unit. It could well be this webpage is placed at such a position in the tree structure so that the user has to click through many other web pages in order to arrive at this webpage. The static structure of the intranet or the portal does not recognize the behavior of the user and does not rearrange the web pages in order to shorten the way the user has to walk through the tree structure in the future. The reason that the user might have to click through many other web pages until he arrives at his favorite webpage might be that he is the only one that uses the webpage and that an administrator has therefore decided to place this webpage at a position in the tree structure which is far from the starting webpage.

A system administrator cannot accomplish the ‘perfect arrangement’ of the topology of the plurality of web pages. He cannot arrange the web pages in the tree structure in a way so that the requirements of all users are meet. The system administrator does not have the knowledge and time to do that based on the user's wishes and moreover, the user's behavior might also change over the time.

There is therefore a need for an improved method and data processing system for restructuring web content.

### SUMMARY OF THE INVENTION

The present invention provides a method of restructuring web content, wherein the web content consists of a plurality of web pages and wherein the method comprises the step of generating a log file. The log file comprises a history of web pages and the history of web pages comprises all web pages that have been selected by a user from the plurality of web pages. The method further comprises the steps of determining an access frequency for each webpage selected by the user. The access frequency is determined by use of the history of web pages. Then a subset of web pages is determined. The subset of web pages contains a maximum number of web pages. The maximum number of web pages is predefined. The subset of web pages contains the web pages that have the largest access frequencies.

Thus in the log file a history of web pages that have been visited by the user is collected. For each webpage an access frequency is determined. By use of the access frequencies that have been determined for each webpage the web pages that are visited by the user the most often are determined. There is a maximum number of web pages which are assigned to the subset of web pages. This subset of web pages contains the given number of web pages that are visited or accessed by the user the most frequently.

The method in accordance with the invention therefore determined the user's favorite web pages, which are the web pages comprised in the subset of web pages, by parsing and analyzing the log file. The given number is a specified but configurable number.

According to an embodiment of the invention, the plurality of web pages is arranged in a tree structure, wherein the tree structure is rooted at a starting web page, wherein the subset of web pages is accessible by the user from a portlet, wherein the portlet is linked to the starting webpage. Thus, the subset of web pages is now accessible by the user directly from the portlet which is only one click away from the starting webpage. The method in accordance with the invention is therefore particularly advantageous as it allows a user to directly access his favorite web pages directly from the portlet, which he can access directly from the starting web page. He therefore does not have to click through all other web pages in order to arrive at one of his favorite web pages.

In accordance with an embodiment of the invention, the plurality of web pages is arranged in a tree structure, wherein the tree structure is rooted at a starting webpage, wherein a user specific special webpage is linked to the starting webpage, wherein the subset of web pages is determined at the point in time when the user accesses the user specific special webpage, wherein to each webpage comprised in the subset of web pages a transient label is assigned to, wherein each transient label is linked to the user specific special webpage, and wherein the user is able to access the subset of web pages via the corresponding transient label. The subset of web pages is determined at the point in time when the user accesses the user specific special webpage. This ensures that the subset of web pages which is determined by use of the access frequencies that have been determined for each webpage that has been accessed by the user always contains the web pages that are most frequently visited by the user. The user can then access the subset of web pages directly from the user specific special webpage. He therefore does not have to click through all other web pages in order to access one of his favorite web pages.

In accordance with an embodiment of the invention, the plurality of web pages is arranged in a tree structure, wherein the tree structure is rooted at a starting web page. A transformation is attached to the starting web page. The subset of web pages is determined at the point in time when the user accesses the staring web page. A dynamic sub-model of web pages is determined by use of the transformation, whereby the subset of web pages is accessible for said user from the staring web page.

In accordance with an embodiment of the invention, the plurality of web pages is comprised in a portal. The method in accordance with the invention is particularly advantageous, when the plurality of web pages are accessed via the portal. Since the applications or services that are provided by the portal are possibly accessible by a large variety of users, the method in accordance with the invention provides a way to dynamically arrange the structure of the portal, whereby the specific needs of each user are meet.

According to an embodiment of the invention, the portal comprises a logging component, a parsing component and a visualization component, wherein the logging component is used for the generation of the log file, wherein the parsing component is used for semantically analyzing the log file, and wherein the visualization component is used for the visualization of the subset of pages within the portal.

In accordance with an embodiment of the invention, the logging component is Tivoli's Site Analysis Tool, and the log file is a NSCA combined access log file.

In accordance with an embodiment of the invention, the access frequency of a webpage is measured by the number of times the user accesses the webpage or by the time the user spends on the webpage. An access frequency which takes into account the time a user spends on a web pages has the advantage that a web page which is only used by the user in order to access another web page does usually not have a high access frequency.

In accordance with an embodiment of the invention, the access frequency is only determined for a webpage if no other webpage is accessed from the webpage. Thus no access frequency is determined for a webpage which is only visited by a user in order to browse to another webpage. This has the advantage that only the web pages that are actually used by the user are assigned to the subset of web pages.

In another aspect the invention relates to a computer program product comprising computer executable instructions for performing the method in accordance with the invention.

In another aspect, the invention relates to a data processing system for identifying user specific favorite web pages from a plurality of web pages. The data processing system comprises means for generating a log file. The log file comprises a history of web pages and the history of web pages comprises all web pages that have been selected by a user from the plurality of web pages. The data processing system further comprises means for determining an access frequency for each webpage selected by the user. The access frequency is determined by use of the history of web pages. The data processing system further comprises means for determining the subset of web pages. The subset of web pages contains a maximum number of web pages. The maximum number is predefined and the subset of web pages contains the web pages that have the largest access frequency.

### BRIEF DESCRIPTION OF THE DRAWINGS

In the following, preferred embodiments of the invention will be described in greater detail by making reference to the drawings in which:

FIG. 1 shows a block diagram of a data processing system for restructuring web content,

FIG. 2 shows a flow diagram that illustrates the basic steps for restructuring web content,

FIG. 3 shows a flow diagram that depicts the steps for restructuring web content,

FIG. 4 shows a flow diagram that illustrates the steps for restructuring the web content,

FIG. 5 shows a block diagram of web content consisting of a multiple of web pages that are arranged in a tree structure,

FIG. 6 shows the starting web page of a portal used for the administration of air traffic,

FIG. 7 shows the web page of the portal by which a user can access the subset of web pages,

FIG. 8 depicts the web page of the portal from which the user is able to access his favorite web pages,

FIG. 9 shows the web page of the portal by which the user can access the subset of web pages,

FIG. 10 depicts the web page of the portal from which the user is able to access his favorite web pages,

### DETAILED DESCRIPTION

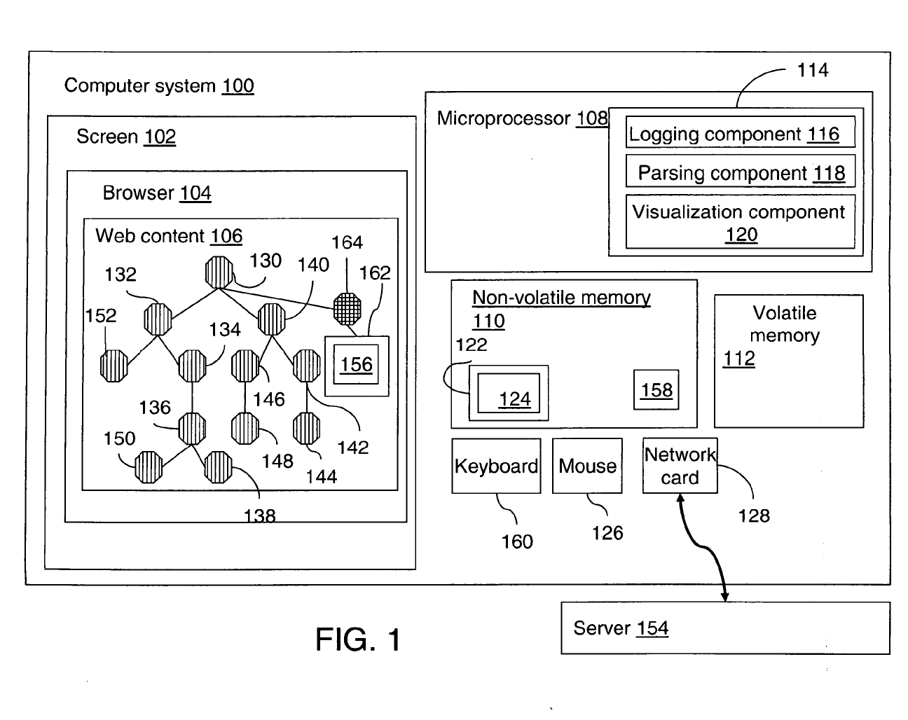

FIG. 1 shows a block diagram of a data processing system for restructuring web content 106. The data processing system comprises a computer system 100 which comprises a screen 102, a microprocessor 108, a non-volatile memory device 110, a volatile memory device 112, a keyboard 160, a mouse 126, and a network card 128. The computer system 100 can for example be a client computer that is connected by means of the network card 128 to a server 154.

A browser 104 is visualized on the screen 102. Web content 106 can be loaded from the server 154 to the computer system 100 by use of the network card 128 and visualized within the browser 104. The web content 106 consists of a plurality of web pages 130, . . . , 150 that are arranged in a tree structure. The tree structure is rooted at the starting webpage 130. A webpage is accessible from another webpage by a link that is placed on the webpage. For example, the starting web page 130 comprises a link through which web page 132 can be reached and another link through which web page 140 is accessible. A user generally enters the web content 106 at the starting page 130. The user can then navigate through the web pages 130, . . . , 150 by use of the mouse 126 or via the keyboard 160. For example, if he wants to access web page 138, he enters web page 132 by the appropriate link that is placed on web page 130. Then he navigates from web page 132 to web page 134 from where he accesses web page 136. On web page 136, he clicks on the link through which he can access web page 138.

The microprocessor 108 executes a computer program product 144 which monitors the actions of the user performed on the web pages 130, . . . , 150. The computer program product 114 comprises a logging component 116. The logging component 116 generates a log file 122 which is stored on the non-volatile memory device 110 or alternatively on the volatile memory device 112. The log file 122 comprises a history of web pages 124. In the history of web pages 124 all web pages that have been visited by the user are recorded. The history of web pages 124 might for example be of the form of a list in which in each line one web page visited by the user is recorded along with the user's ID, the point in time when the user accessed the web page and the amount of time the user spent on the web page. The access of a user to the web page 138 from the starting web page 130 might for example be recorded in the history of web pages 124 as follows:

USER ID, webpage 130, T=11:00:00, RP=10 s;
USER ID, webpage 132, T=11:00:10, RP=1 s;
USER ID, webpage 134, T=11:00:15, RP=5 s;
USER ID, webpage 136, T=11:00:20, RP=5 s;
USER ID, webpage 138, T=11:00:25, RP=200 s;

In the first column of the list, the user's ID is recorded, in the second column, the web pages are recorded (in order to access web page 138 from web page 130, the user has to click through web pages 132, 134, and 146). In the third column, the point in time when the user accessed the web page is recorded and in the last column the retention period of the user on the page is stored.

The computer program product 114 further comprises a parsing component 118. The parsing component 118 determines an access frequency 156 which is stored on the non-volatile memory device 110, for each webpage 130, . . . , 144 that has been accessed by the user. The access frequency of a specific webpage is for example determined by the number of times the user has accessed the specific webpage. In order to determine the access frequency, the parsing component 118 scans through the log 122 file and determines the number of entries of the specific webpage. Thus by scanning the list given above, the access frequencies of web page 130, 132, 134, 136, and 138 would be one, since each web page is only listed once.

The access frequency of a specific webpage can also be determined by the time the user has spent on the specific webpage normalized to for example one second. Thus, from the list given above, the access frequency of web page 138 is determined to be 200, while the access frequency of web page 132 is 1.

This ensures that the access frequency of page 138 is higher than the access frequency of page 132 which might only be visited by the user in order to access page 138 and thus might not be of much interest to the user.

Alternatively, the access frequency of a specific webpage is determined only when no other web page is accessed by the specific web page. The access frequency is then measured by the number of web pages that had to be clicked through from the starting web page in order to access the specific web page. For example, an access frequency would only be determined for the web page 138 recorded in the list above. For all other web pages no access frequency would be determined. The access frequency would be measured by the number of web pages that were accessed in order to arrive at web page 138. Thus the access frequency of web page 138 would be 3, since web page 132, web page 134, and web page 136 were accessed in order to arrive at web page 138.

In the case when the user only uses the web pages 138 and 144 and he only clicks through all other pages in order to access the web pages 138 or 144, then the two web pages 138, 144 would be the web pages with the highest access frequencies. The subset of web pages 162 holds a given maximum number 156 of web pages that have the highest access frequencies. Assume the maximum number 156 is equal to two. Then the web pages 138 and 144 would be assigned to the subset of web pages 162. The number 156 can for example be specified by a system administrator or by the user himself.

In an embodiment of the invention, a portlet 164 is created which is directly linked to the starting web page 130. The subset of web pages 162 is linked to the portlet so that the user is able to access the subset of web pages 162, in the example given above the web pages 138 and 144, directly from the starting page 130 via the portlet 164. Hence he does not have to click through all the other web pages anymore in order to be able to access web page 138 and 144.

In another embodiment of the invention, a user specific webpage is linked to the starting webpage. The subset of web pages 162 is determined at the point in time when the user accesses a user specific special webpage. A transient label is assigned to each webpage contained in the subset of web pages. The transient label is linked to the user specific webpage. The user is able to access a webpage contained in the subset of web pages via the corresponding transient label. This will be described in greater detail below.

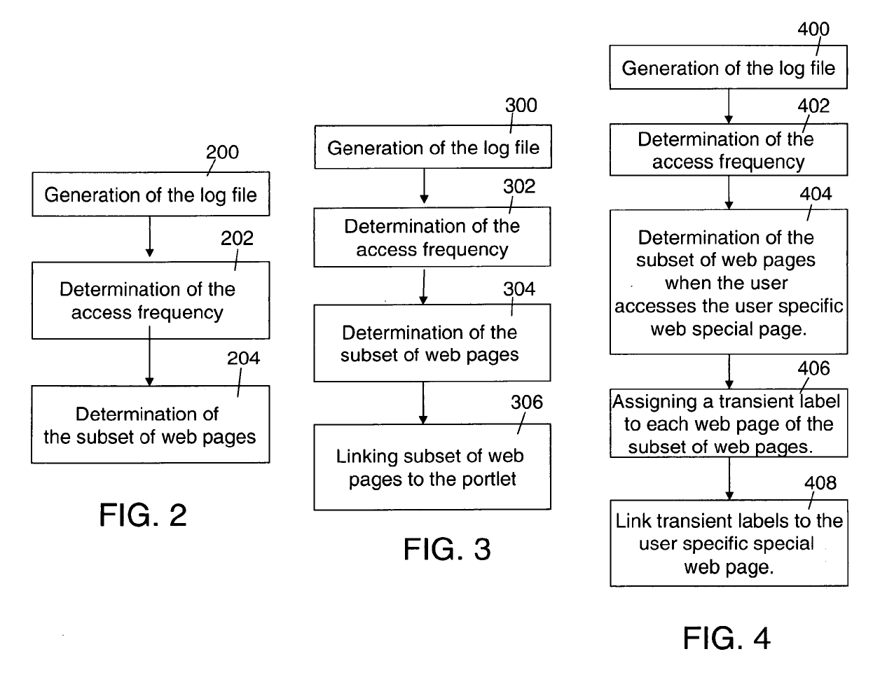

FIG. 2 shows a flow diagram depicting the basic steps for restructuring the web content. In step 200, a log file is generated. The log file comprises a history of web pages and the history of web pages comprises all web pages that have been selected by a user from the plurality of web pages that is contained in the web content. In step 202, an access frequency is determined for each webpage that has been selected by the user. The access frequency is determined by use of the history of web pages. In step 204, the subset of web pages is determined. The subset of web pages contains a predefined maximum number of web pages. These web pages are the web pages that are accessed by the user the most frequently. Thus the subset of web pages contains the favorite web pages of the user.

FIG. 3 shows a flow diagram depicting the steps for restructuring the web content. In step 300, the log file is generated which comprises the history of web pages that have been selected by the user from the plurality of web pages. In step 302, the access frequency of each webpage that has been selected by the user is determined. By use of the access frequencies that are available for each webpage a subset of web pages is determined in step 304. The subset of web pages comprises a maximum number of web pages. These web pages are the web pages that have been accessed by the user the most frequently. Thus the subset of web pages comprises the web pages that are the user's favorite web pages. In step 306 the subset of web pages is linked to a portlet. The portlet is directly linked to the starting webpage so that a user can directly access his favorite web pages by use of the portlet.

FIG. 4 shows a flow diagram that illustrates the steps for restructuring the web content. In step 400 the log file is generated which contains the history of web pages that have been accessed by the user. In step 402 the access frequency is determined for each webpage that has been accessed by the user. In step 404 the subset of web pages is determined at the point in time when the user accesses a user specific special page. A transient label is assigned to each webpage of the subset of web pages in step 406, and in step 408 the transient label is linked to the user specific special webpage.

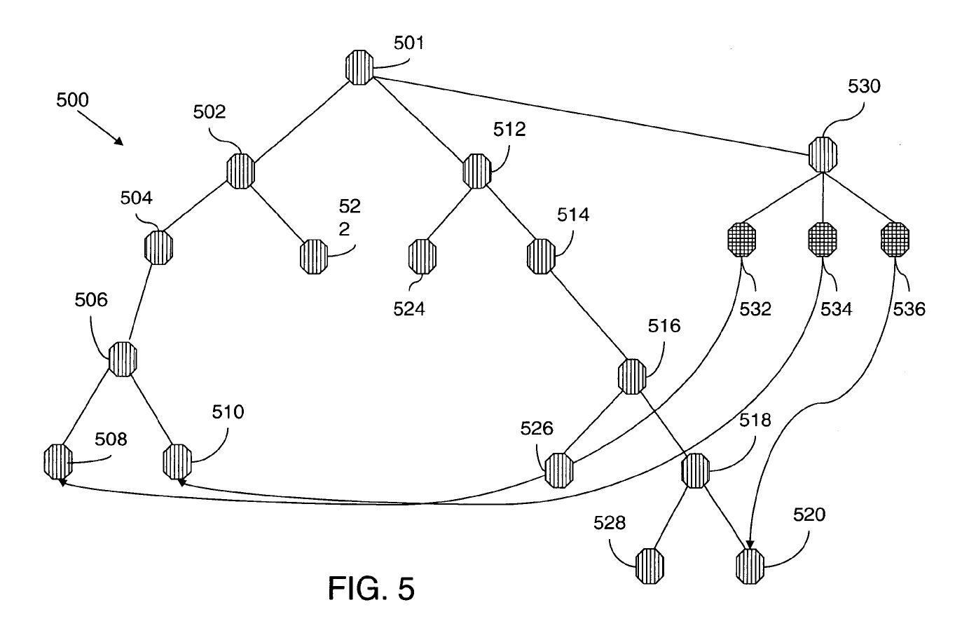

FIG. 5 shows a block diagram 500 of the web content that consists of a multiple of web pages that are arranged in a tree structure. The tree structure is rooted at a starting page 501. Consider that the user uses the most often the web pages 508, 510 and 520. In order to arrive at the webpage 508, the user must navigate through the web pages 502, 504, 506 and then finally he arrives at 508. Alternatively, he can click from page 506 to page 510 whereby he arrives at another one of his favorite web pages. Thus he always needs four clicks in order to arrive at 508 or at webpage 510. If the user wants to use the webpage 520 he has to browse from the starting page 501 to the page 512 then to the page 514 then to the page 516 then to 518 and then finally he arrives at the webpage 520. Thus he has to browse through four other pages in order to arrive at the webpage 520. If he uses the web pages 508, 510 and 520 frequently, the access frequency of these three pages will be high. If the maximum number of pages that are contained in the subset of web pages is larger than three, then these three pages will be identified as the user's favorite pages. These three pages will be the pages with the largest access frequency. Hence the subset of web pages will consist of the web pages 508, 510 and 520.

The user specific special web page 530 is directly linked to the starting page 501. Since web pages 508, 510 and 520 are the user's favorite web pages a transient label will be assigned to each of these web pages. The transient label 332 is assigned to webpage 508. The transient label 534 is assigned to the webpage 510, and the transient label 536 is assigned to the webpage 520. Whenever the user accesses the starting webpage the process of determining the subset of web pages is started. Hence the transient labels are determined dynamically at the point in time when the user access the web page 530 and are adapting to the behavior of the user. If the user starts accessing webpage 522 more frequently and does not access webpage 508 as frequently as before, then the transient label 532 will be assigned to webpage 522 when the access frequency of web page 522 becomes larger than the access frequency of web page 508. The user can access the pages he uses the most often via the user specific special web page 530. He does not need to browse through for example the web pages 512, 514, 516 and 518 anymore in order to access the webpage 520.

Alternatively, the concept of a special web page or the portlet could be dropped and a transformation that rearranges the web content 501, . . . , 528 could be directly attached to the starting web page 501. By applying the same analysis method in accordance with the invention, the user's favorite web pages, which could for example be web pages 508, 510, and 520, can be identified. The user's favorite web pages 508, 510, and 520 are then directly accessible from staring web page 501. All web pages below the starting web page 501 to which the transformation has been assigned to would thus be dynamic web pages which would be part of an on-the-fly constructed dynamic sub-model, just representing the most reasonable structure matching the user's behavior. Here, the dynamic labels would not be linked to the user's favorite web pages. They would be real web pages instead of labels only and would contain the content of the underlying web page to which they refer to. A click on the starting web page 501 would thus directly render the content the user wants to access.

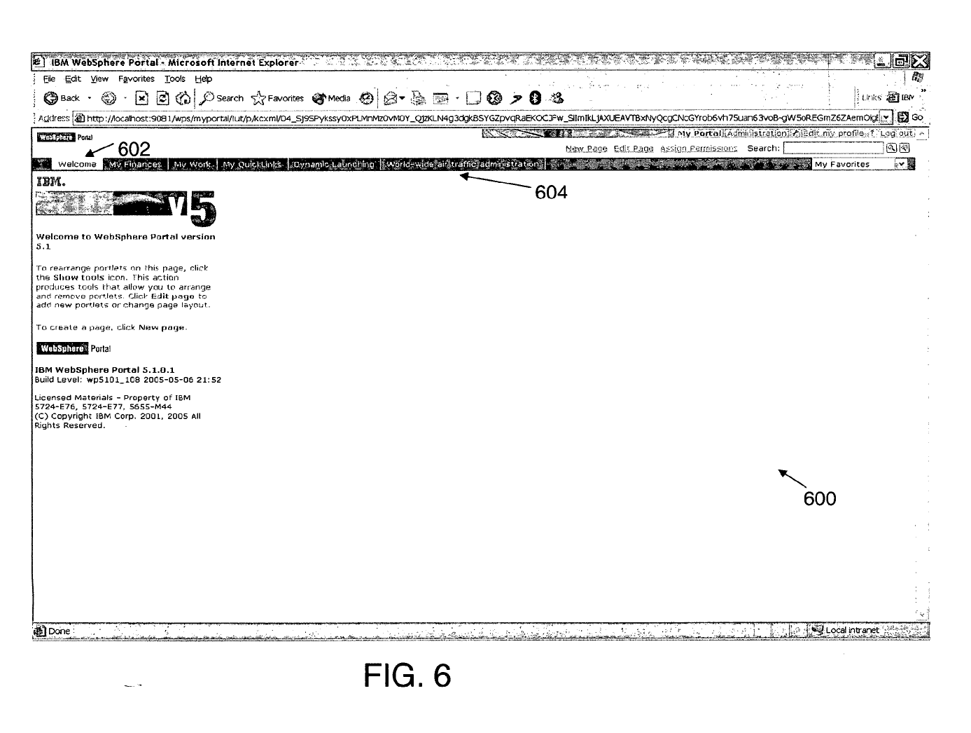

FIG. 6 shows the starting web page 600 of a portal used for the administration of air traffic. The portal is implemented by the commercial program WepSphere Portal from IBM Corporation. The user accesses the portal at the starting web page 600. The starting web page 600 is characterized in that the “Welcome” register 602 which is contained in the tool bar 604 is set apart from the tool bar 604 by use of a different color coding.

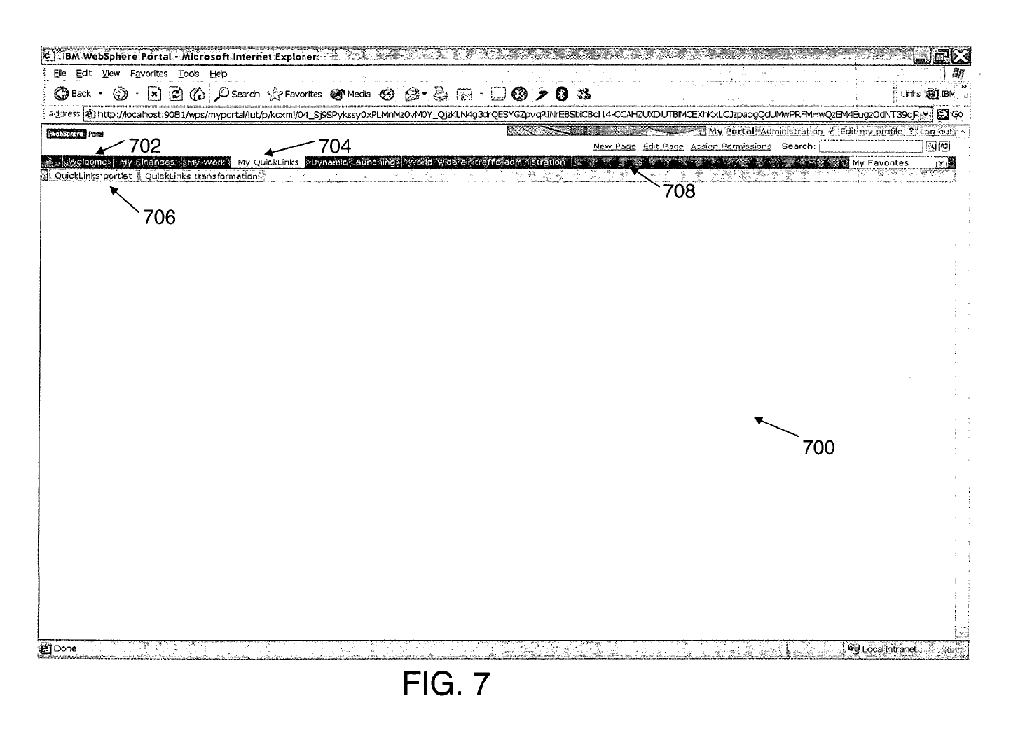

FIG. 7 shows the web page 700 of the portal by which a user can access the subset of web pages. The user is able to access the web page 700 of the portal from which he can access the subset of web pages by clicking on the “My QuickLinks” register 704 which is also contained in the tool bar 708. When he chooses the “My QuickLinks” register 704, this register is set apart from the tool bar 708 by a different color whereas the “Welcome” register 702 takes the color of the tool bar 708. From the web page 700, a “QuickLinks” portlet 706 becomes accessible for the user.

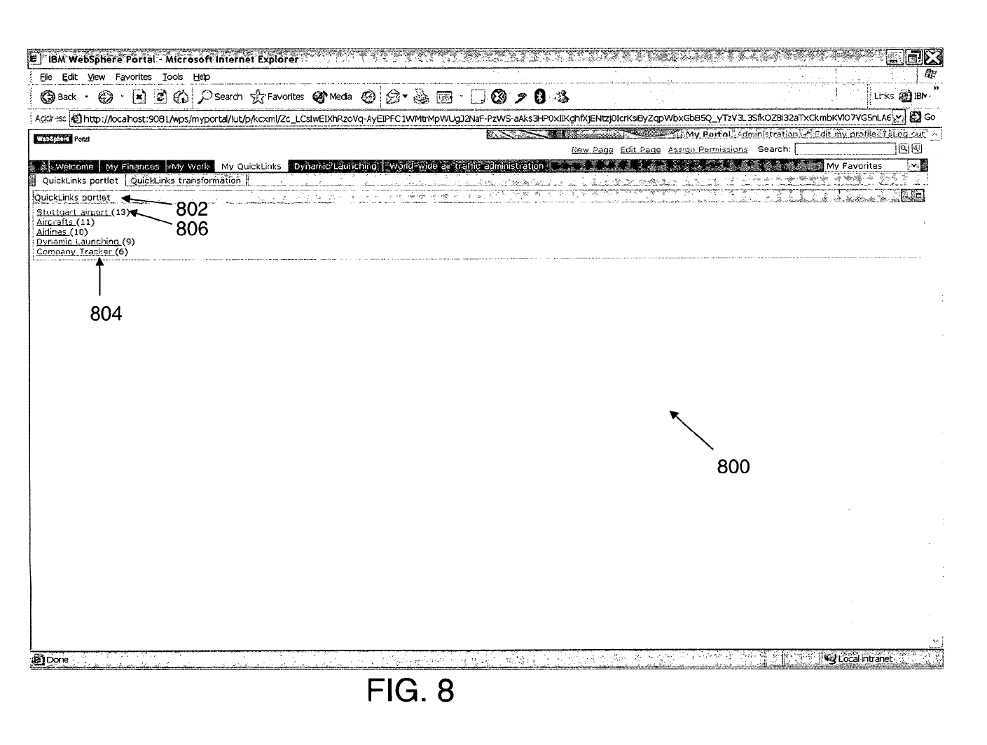

FIG. 8 depicts the web page 800 of the portal from which the user is able to access his favorite web pages. The user chooses the “QuickLinks” portlet 802 by clicking on it, and in response, a list which contains the subset of web pages 804 opens up. The subset of web pages 804 comprises links to the web pages that have been visited by the user during previous sessions the most frequently. The subset of web pages 804 contains the user's favorite web pages. If the user is for example administrator of Stuttgart airport he would have selected frequently the web page by which he can administrate Stuttgart airport. Thus, the subset of web pages 804 contains a link to “Stuttgart airport” 806. By clicking on the “Stuttgart airport” link 806, the user is able to access the web page on which he is able administrate Stuttgart airport.

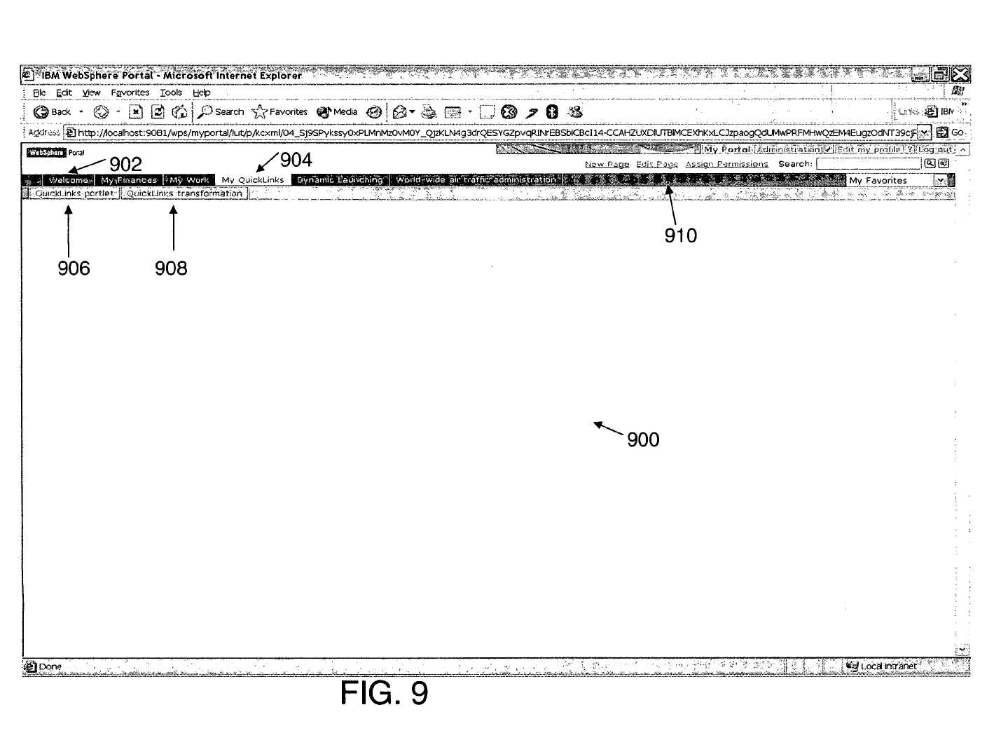

FIG. 9 shows the web page 900 of the portal by which the user can access the subset of web pages. The user is able to access the web page 900 of the portal from which he can access the subset of web pages by clicking on the “My QuickLinks” register 904. When he chooses the “My QuickLinks” register 904, this register is set apart from the tool bar 910 by a different color whereas the “Welcome” register 902 takes the color of the tool bar 900. From the web page 700, a “QuickLinks transformation” web page 908, which corresponds to the user specific special web page, is in addition to the “QuickLinks” portlet 906 accessible for the user.

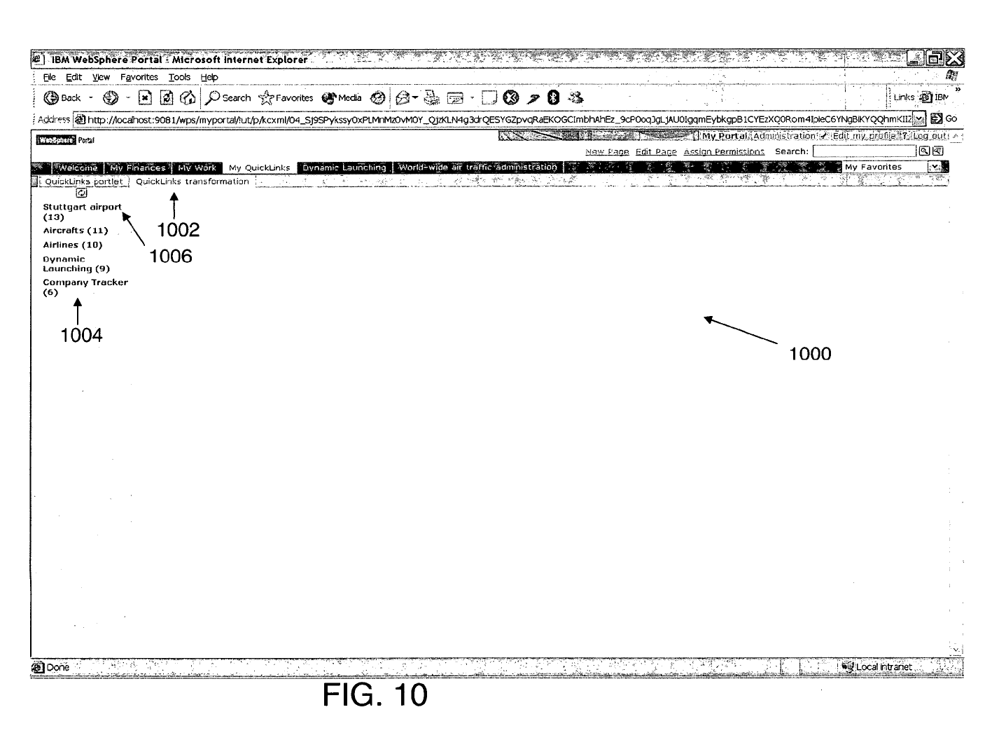

FIG. 10 depicts the web page 1000 of the portal from which the user is able to access his favorite web pages. When the user chooses the “QuickLinks” transformation web page 1002, then the subset of web pages 1004 which contains the users favorite web pages is determined. A transient label is assigned to each web page of the subset of web pages and each transient label is linked to the “QuickLinks” transformation web page 1002. If the user is for example administrator of Stuttgart airport he would have selected frequently the web page on which he can administrate Stuttgart airport. Thus, the subset of web pages 1004 contains a transient label for “Stuttgart airport” 1006 by which the user is able to access the web page on which he is able administrate Stuttgart airport.

List of Reference Numerals

| | |
|---|---|
| 100 | Computer system |
| 102 | Screen |
| 104 | Browser |
| 106 | Web content |
| 108 | Microprocessor |
| 110 | Non-volatile memory device |
| 112 | Volatile memory device |
| 114 | Computer program product |
| 116 | Logging component |
| 118 | Parsing component |
| 120 | Visualization component |
| 122 | Log file |
| 124 | History of web pages |
| 126 | Mouse |
| 128 | Network card |
| 130 | Starting webpage |
| 132 | Webpage |
| 134 | Webpage |
| 136 | Webpage |
| 138 | Webpage |
| 140 | Webpage |
| 142 | Webpage |
| 144 | Webpage |
| 146 | Webpage |
| 148 | Webpage |
| 150 | Webpage |
| 152 | Webpage |
| 154 | Server |
| 156 | Access frequency |
| 158 | Maximum number |
| 160 | Keyboard |
| 162 | Subset of web pages |
| 164 | Portlet |
| 500 | Block diagramm |
| 501 | Starting webpage |
| 502 | Webpage |
| 504 | Webpage |
| 506 | Webpage |
| 508 | Webpage |
| 510 | Webpage |
| 512 | Webpage |
| 514 | Webpage |
| 516 | Webpage |
| 518 | Webpage |
| 520 | Webpage |
| 522 | Webpage |
| 524 | Webpage |
| 526 | Webpage |
| 528 | Webpage |
| 530 | User specific special webpage |
| 532 | Transient label |
| 534 | Transient label |
| 536 | Transient label |
| 600 | Starting web page |
| 602 | “Welcome” register |
| 604 | Tool bar |
| 700 | Web page |
| 702 | “Welcome” register |
| 704 | “MyQuickLinks” register |
| 706 | “QuickLinks” portlet |
| 708 | Tool bar |
| 800 | Web page |
| 802 | “QuickLinks” portlet |
| 804 | Subset of web pages |
| 806 | Stuttgart airport |
| 900 | Web page |
| 902 | “Welcome” register |
| 904 | “My QuickLinks” register |
| 906 | “QuickLinks” portlet |
| 908 | “QuickLinks transformation” |
| 910 | Tool bar |
| 1000 | Web page |
| 1002 | “QuickLinks transformation” |
| 1004 | Subset of web pages |
| 1006 | Stuttgart airport |

1) A method of restructuring web content (104), said web content (104) consisting of a plurality of web pages (130, . . . , 150), said method comprising:
generating a log file (122), said log file (122) comprising a history of web pages (124), said history of web pages (124) comprising all web pages (130, . . . , 144) selected by a user from said plurality of web pages (130, . . . , 150);
determining an access frequency (156) for each web page (130, . . . , 144) selected by said user, said access frequency (156) being determined by use of said history of web pages (124);
determining a subset of web pages (162), said subset of web pages (162) containing a maximum number (158) of web pages, said maximum number (158) being predefined, said subset of web pages (162) containing the web pages having the largest access frequency (156).

2) The method of claim 1, wherein said plurality of web pages (130, . . . , 150) is arranged in a tree structure, wherein said tree structure is rooted at a starting web page (130), wherein said subset of web pages (162) is accessible by said user from a portlet (164), wherein said portlet (164) is linked to said starting web page (130).

3) The method of claim 1, wherein said plurality of web pages (130, . . . , 150) is arranged in a tree structure, wherein said tree structure is rooted at a starting web page (130), wherein a user specific special web page is linked to said starting web page (130), wherein said subset of web pages (162) is determined at the point in time when said user accesses said user specific special web page, wherein to each web page comprised in said subset of web pages (162) a transient label is assigned to, wherein each transient label is linked to said user specific special web page, wherein said user is able to access the subset of web pages (162) via the corresponding transient label.

4) The method of claim 1, wherein said plurality of web pages (130, . . . , 150) is arranged in a tree structure, wherein said tree structure is rooted at a starting web page (130), wherein a transformation is attached to said starting web page (130), wherein said subset of web pages (162) is determined at the point in time when said user accesses said staring web page (130), wherein a dynamic sub-model of web pages is determined by said transformation, whereby said subset of web pages (162) is accessible for said user from said staring web page (130).

5) The method of claim 1, wherein said plurality of web pages (130, . . . , 150) is comprised in a portal.

6) The method of claim 5, wherein said portal comprises a logging component, a parsing component, and a visualization component, wherein said logging component is used for the generation of said log file, wherein said parsing component is used for the selection of said subset of web pages, and wherein said visualization component is used for the visualization of said subset of pages within said portal.

7) The method of claim 6, wherein said logging component is Tivoli's Site Analysis Tool, and wherein said log file is a NSCA combined access log file.

8) The method of claim 1, wherein the access frequency of a web page is measured by the number of times said user accesses said web page or by the total amount of time said user spends on said web page.

9) The method of claim 1, wherein the access frequency is only determined for a web page if no other web page is accessed by the user from said web page.

10) A computer program product comprising computer executable instructions for performing a method in accordance with the steps of:
generating a log file (122) said log file (122) comprising a history of web pages (124), said history of web pages (124) comprising all web pages (130, . . . , 144) selected by a user from said plurality of web pages (130, . . . , 150);
determining an access frequency (156) for each web page (130, . . . , 144) selected by said user, said access frequency (156) being determined by use of said history of web pages (124);
determining a subset of web pages (162), said subset of web pages (162) containing a maximum number (158) of web pages said maximum number (158) being predefined, said subset of web pages (162) containing the web pages having the largest access frequency (156).

11) A data processing system for restructuring web content (104), said web content (104) comprising a plurality of web pages (130, . . . , 150), said data processing system comprising:
means for generating a log file (122), said log file (122) comprising a history of web pages (124), said history of web pages (124) comprising all web pages (130, . . . , 144) selected by a user from said plurality of web pages (130, . . . , 150);
means for determining an access frequency (156) for each web page (130, . . . , 144) selected by said user, said access frequency (156) being determined by use of said history of web pages (124);
means for determining a subset of web pages (162), said subset of web pages (162) containing a maximum number (158) of web pages, said maximum number (158) being predefined, said subset of web pages (162) containing the web pages having the largest access frequency (156).

12) The data processing system of claim 11, wherein said plurality of web pages is arranged in a tree structure, wherein said tree structure is rooted at a starting web page, wherein said data processing system provides means for said user for accessing said subset of web pages from a portlet, wherein said portlet is linked to said starting web page.

13) The data processing system of claim 11, wherein said plurality of web pages is arranged in a tree structure, wherein said tree structure is rooted at a starting web page, wherein a user specific special web page is linked to said starting page, wherein said data processing system provides means for determining said subset of web pages at the point in time when said user accesses said user specific special web page, wherein said data processing method comprises means for assigning a transient label to each web page comprised in said subset of web pages a transient label, wherein each transient label is linked to said user specific special web page, wherein said user is able to access the subset of web pages via the corresponding transient label.

14) The data processing system of claim 11, wherein said plurality of web pages (130, . . . , 150) is arranged in a tree structure, wherein said tree structure is rooted at a starting web page (130), wherein said data processing system comprises means for attaching a transformation to said starting web page (130), means for determining said subset of web pages (162) at the point in time when said user accesses said staring web page (130), and means for determining a dynamic sub-model of web pages is by said transformation, whereby said subset of web pages (162) is accessible for said user from said staring web page (130).

15) The data processing system of claim 11, wherein said plurality of web pages is comprised in a portal.

16) The data processing system of claim 15, wherein said portal comprises a logging component, a parsing component, and a visualization component, wherein said logging component is used for the generation of said log file, wherein said parsing component is used for the selection of said subset of web pages, and wherein said visualization component is used for the visualization of said subset of pages within said portal.

17) The data processing system of claim 16, wherein said logging component is Tivoli's Site Analysis Tool, and wherein said log file is a NSCA combined access log file.

18) The data processing system of claim 11, wherein the access frequency of a web page is measured by the number of times said user accesses said web page or by the total amount of time said user spends on said web page.

19) The data processing system of claim 11, wherein the access frequency is only determined for a web page if no other web page is accessed by the user from said web page.
